(19) United States
(12) Patent Application Publication
(10) Pub. No.: US 2005/0222004 A1
(43) Pub. Date: Oct. 6, 2005

(54) Particulate bleaching composition

(75) Inventors: Leo Gagliardi, Rome (IT); Stefano Resta, Genzano (Rome) (IT); Luca Sarcinelli, Rome (IT); Andrea Esposito, Rome (IT)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/096,111

(22) Filed: Mar. 31, 2005

(30) Foreign Application Priority Data
Apr. 5, 2004 (EP) 04447089.6

(51) Int. Cl. C11D 7/18

(52) U.S. Cl. 510/376

(57) ABSTRACT

The present invention relates to a particulate bleach additive composition comprising an imido-type peroxy acid and a source of protons.

### TECHNICAL FIELD

The present invention relates to a particulate bleach additive composition, which can be used to bleach fabrics in conjunction with a conventional granular or liquid laundry detergent.

### BACKGROUND OF THE INVENTION

Commonly encountered particulate bleaching compositions suitable for the bleaching of stains on fabrics are based on halogen bleaches, especially hypochlorite bleaches, or peroxygen oxygen bleaches.

Particulate bleaching compositions based on peroxygen oxygen bleaches suitable for the bleaching of stains on fabrics are based on so-called persalt bleaches such as sodium perborate, in its various hydrate forms, or on sodium percarbonate. Such persalt bleaches are sources of hydrogen peroxide when used in aqueous washing conditions. Typically to overcome poor bleaching performance of hydrogen peroxide alone, persalt bleaches are formulated in granular compositions with so-called bleach activators, such as TAED or NOBS. The bleach activators are species that react with hydrogen peroxide to form a peroxyacid or peracid. However, the disadvantage connected to such activated bleaching compositions, is the bleach activators' requirement for certain temperature conditions to react with peroxide. Furthermore, the dissolution of the activator and of the bleach source can pose a problem.

To overcome the above disadvantageous, pre-formed peroxy carboxylic acid have been developed. It has been found that bleaching compositions based on pre-formed peroxy carboxylic acid show a good bleaching performance, when used in laundry applications, especially as so-called bleach additives, and are also safe to fabrics and/or colors. Indeed, peroxy carboxylic acids are known in the art, for example from EP-A-0 435 379.

Furthermore, the use of such peroxy carboxylic acid to treat fabrics has been described in the art, e.g., in WO 00/27963, WO 00/27964, WO 00/27965, WO 00/27966, WO 00/27967, WO 00/27977 and WO 2002/12431.

It has been found that chemical stability of currently known peroxy carboxylic acid-based bleach additives was below expectations. In addition, preformed peroxy carboxylic acids represent a challenge to be handled at bleach additives manufacturing plants.

These difficulties have recently been overcome with the use of imido-type peroxy acids, which being solids with good crystalline properties and high melting points are safer to be handled at manufacturing plants, and due to the fact that imido-type peroxy acids are solid, stability in particular in particulate bleaching compositions, is easier to achieve. A specific class of imido-type peroxy acids are of imido-type peroxy alkanoic acids, especially phthalimido peroxy alkanoic acids, and in particular ε-phthalimido peroxy hexanoic acid (PAP).

However, given their chemical structure, imido-type peroxy acids when present in bleach additives are not stable upon use at the pH of the wash liquor formed by conventional particulate laundry detergents. By “bleach additives” it is meant herein, a particulate composition that is used in conjunction with, this means added to the washing machine together with, a conventional laundry detergent, in particular a particulate laundry detergent, in a laundry washing operation.

Usually, conventional particulate laundry detergents (like ARIEL powder) provide a pH in the wash above 9.5. The imido moiety of the peracid hydrolyzes quantitatively and irreversibly at such a pH (as described in REINHARDT, G. 1994b: Imidoperoxicarbonsäuren als potentielle Bleichmittel für die Waschmittelindustrie. SÖFW-Journal 120: 411-416). This leads to a hydrophilic molecule, which has been observed to provide bleaching performance of the wash liquor per-se in the washing machine (formed by the laundry detergent, the bleach additive and water) rather than stains on fabrics being washed in the washing machine. Indeed, currently known imido-type peroxy acids-based bleach additives failed to provide adequate bleaching performance on stains when used in combination with particulate detergents. This effect is not or at least to an insignificant extent observed in so-called pretreater bleaching compositions comprising imido-type peroxy acids, wherein the pretreater is applied onto the fabric prior to the washing or rinsing and left to act thereon for an effective amount of time.

It is thus an objective of the present invention to provide a particulate bleach additive comprising an imido-type peroxy acids, which delivers effective bleaching performance on stained fabrics, when used in conjunction with a conventional particulate laundry detergent.

It has now been found that the particulate bleach additives comprising an imido-type peroxy acid and a source of protons according to the present invention meets the above objective.

An advantage of the compositions of the present invention is that the particulate bleach additives herein are suitable for the bleaching of different types of fabrics including natural fabrics, (e.g., fabrics made of cotton, and linen), synthetic fabrics such as those made of polymeric fibres of synthetic origin (e.g., polyamide-elasthane) as well as those made of both natural and synthetic fibres. For example, the particulate bleach additives of the present invention herein may be used on synthetic fabrics despite a standing prejudice against using bleaches on synthetic fabrics, as evidenced by warnings on labels of clothes and commercially available bleaching compositions like hypochlorite-containing compositions.

Another advantage of the particulate bleach additives according to the present invention is that they can be used in a variety of conditions, i.e., in hard and soft water.

Yet another advantage of the compositions of the present invention is that they exhibit also effective stain removal performance on various stains including enzymatic stains and/or greasy stains.

### BACKGROUND PRIOR ART

DE-A-100 20 767 describes particulate laundry additives for use with detergents comprising Na percarbonate and citric acid. The compositions further comprise high levels of alkaline material, such as Carbonate or percarbonate or NaHCO₃. Even though the amount of acid would be sufficient to lower the pH of the wash liquor to below 9, the presence of the alkaline material counterbalances the acid and prevents the reduction of the pH through the wash.

### SUMMARY OF THE INVENTION

The present invention encompasses a particulate bleach additive composition comprising an imido-type peroxy acid and a source of protons having at least one acidic moiety donating protons in water at a pH below 7.5, wherein said composition comprises at least 0.80 mmoles of protons available at pH below 7.5 per gram of composition, when dissolved in 10 ml of water.

In addition, the present invention encompasses a process of treating fabrics which comprises the steps of forming an aqueous bath comprising water, a conventional laundry detergent, preferably a granular laundry detergent, and a particulate bleach additive composition according to the present invention, and subsequently contacting said fabrics with said aqueous bath.

Furthermore, the present invention encompasses the use of a source of protons having at least one acidic moiety donating protons in water at a pH below 7.5, in a particulate bleach additive composition comprising an imido-type peroxy acid, wherein said composition comprises at least 0.80 mmoles of protons available at pH below 7.5 per gram of composition when dissolved in 10 ml of water, to provide effective bleaching performance on stained fabrics, when used in conjunction with a conventional particulate laundry detergent.

### BRIEF DESCRIPTION OF THE DRAWING

FIG. 1 is a plot showing the a titration curve of an average wash solution formed by a conventional particulate laundry detergent. Indeed, 110 grams of ARIEL® granular detergent were dissolved in 12 liters of water, which represents the recommended dosage of a granular detergent in a washing machine (under European washing conditions), and titrated with a composition comprising 10% of citric acid and 90% of water. The plot shows the pH of the wash solution versus the concentration of protons coming from the citric acid-containing composition.

### DETAILED DESCRIPTION OF THE INVENTION

The Particulate Bleach Additive Composition

The particulate bleaching compositions herein are so called particulate bleach additive compositions suitable for use in conjunction with a conventional laundry detergent, and in particular with particulate laundry detergents, to treat (stained) fabrics. The terms “additive” or “through-the-wash (bleaching) composition” refer to compositions that are preferably employed in the specific process of treating, preferably bleaching, fabrics as encompassed by the present invention.

Indeed, additive compositions are added together with a conventional laundry detergent (preferably particulate laundry detergent) into a washing machine and are active in the same wash-cycle. By contrast, so-called ‘spotter’ or ‘pretreater’ compositions that are applied, mostly undiluted, onto fabrics prior to washing or rinsing the fabrics and left to act thereon for an effective amount of time. Furthermore, so-called ‘soakers’ or ‘rinse-added’ compositions are contacted, mostly in diluted form, with fabrics prior or during rinsing of fabrics with water.

The bleach additive compositions herein are particulate compositions. By “particulate” it is meant herein powders, pearls, granules, tablets and the like.

Particulate compositions are preferably applied onto the fabrics to be treated dissolved in, an appropriate solvent, typically water.

The particulate bleach additive composition herein have a pH measured at 25° C., preferably of at least, with increasing preference in the order given, preference in the order given, 0.1, 0.5, 1, 1.5, 2, 2.5, 3, 3.5, 4, 4.5, 5, 5.5, 6, 6.5, 7, when diluted into 1 to 500 times its weight of water. Independently, particulate bleach additive composition herein have a pH measured at 25° C., preferably of no more than, with increasing preference in the order given, 12, 11.5, 11, 10.5, 10, 9.5, 9, 8.5 or 8, when diluted into 1 to 500 times its weight of water.

The pH of the compositions is governed by the concentration and type of source of protons as discussed herein below.

The bleaching performance of the particulate bleach additive compositions may be evaluated by the following test methods on various types of bleachable stains:

A suitable test method for evaluating the bleaching performance on a soiled fabric under additive-conditions (also referred herein as “through-the-wash” conditions) is the following: A particulate bleach additive composition is used in the wash-cycle of a conventional washing machine. The particulate bleach additive composition is added together with a conventional particulate laundry detergent (such as DASH® powder, TIDE®, ARIEL tablets®, ARIEL® powder). The particulate bleach additive composition is dosed at 30 grams per wash-load and the conventional laundry detergent is dosed at 110 grams per wash load for granules and 2 tabs per wash load for tablets (recommended dosages). In the washing machine the soiled fabrics are washed according to the standard procedure of the washing machine at a temperature of from 30° to 70° C. for 10 to 100 minutes and then rinsed. Reference composition(s) in the comparative test undergo the same treatment. Soiled fabrics/swatches with for example tea, coffee and the like may be commercially available from E.M.C. Co. Inc.

A visual grading may be used to assign difference in panel units (psu) in a range from 0 to 4, wherein 0 means no noticeable difference in bleaching performance between a particulate bleach additive composition according to the present invention and a reference composition and 4 means a noticeable difference in bleaching performance between a particulate bleach additive composition according to the present invention and a reference composition.

Imido-Type Peroxy Acids

The bleaching composition of the present invention comprises an imido-type peroxy acid. Said imido-type peroxy acid is preferably a solid, substantially water insoluble pre-formed imido-type peroxy acid. In a preferred embodiment of the present invention the imido-type peroxy acid has the general formula:
X—R—C(O)OOH
wherein R is a linear or branched, substituted or unsubstituted hydrocarbon chain having at least 1 carbon atom and X is a substituted imide, preferably a substituted imide wherein the imidic nitrogen forms a bond with R.

By a “substituted imide” it is meant herein an imide having a substitution on the nitrogen.

Preferably the imido-type peroxy acid is according to the general formula: 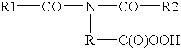
wherein R1 and R2 are independently linear or branched, substituted or unsubstituted hydrocarbon chains having at least 1 carbon atom, preferably aliphatic or aromatic hydrocarbon chains and may form a ring.

More particularly the R group preferably comprises from 2 to 24 carbon atoms. Alternatively, the R group may be a branched alkyl chain comprising one or more side chains which comprise substituent groups selected from the group consisting of aryl, halogen, ester, ether, amine, amide, substituted phthalic amino, imide, hydroxide, sulphide, sulphate, sulphonate, carboxylic, heterocyclic, nitrate, aldehyde, ketone or mixtures thereof.

In a preferred peracid the X group, according to the above general formula, is a phthalimido group. Thus, particularly preferred imido-type peroxy acids herein are those having general formula: 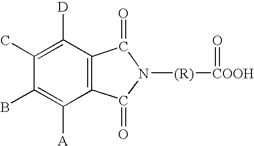
where R is C1-20 alkyl group and where A, B, C and D are independently either hydrogen or substituent groups individually selected from the group consisting of alkyl, hydroxyl, nitro, halogen, amine, ammonium, cyanide, carboxylic, sulphate, sulphonate, aldehydes or mixtures thereof.

In a preferred aspect of the present invention R is an alkyl group having from 3 to 12 carbon atoms, more preferably from 5 to 9 carbon atoms. Preferred substituent groups A, B, C and D are linear or branched alkyl groups having from 1 to 5 carbon atoms, but more preferably hydrogen.

In a preferred embodiment herein, said imido-type peroxy acid is an imido-type peroxy alkanoic acid, preferably a phthalimido peroxy alkanoic acid, even more preferably said imido-type peroxy acid is selected from the group consisting of: ε-phthalimido peroxy hexanoic acid (also known as Phthalimido peroxy caproic acid—PAP); phthalimido peroxy heptanoic acid; phthalimido peroxy octanoic acid; phthalimido peroxy nonanoic acid; and Phthalimido peroxy decanoic acid; and mixtures thereof and most preferably ε-phthalimido peroxy hexanoic acid (PAP).

Suitable phthalimido peroxy alkanoic acid have the general formula: 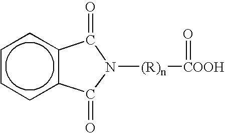
wherein R is selected from C1-4 alkyl and n is an integer of from 1 to 5.

PAP (ε-phthalimido peroxy hexanoic acid) as mentioned above is according to the above formula wherein R is CH₂ and n is 5.

PAP is preferably used as a substantially water-insoluble solid or wet-cake and is available from Ausimont under the trade name Eureco®.

Said imido-type peroxy acid may be present at a level in the composition of from 0.1% to 30% more preferably 0.1% to 20% and most preferably 1% to 15% by weight of the total composition. Alternatively the imido-type peroxy acid may be present at a much higher level of for example 3% to 40%, more preferably from 4% to 30%, most preferably from 5% to 25% by weight of the total composition.

Source of Protons

The compositions herein comprise a source of protons having at least one acidic moiety donating protons in water at a pH below 7.5, wherein said composition comprises at least 0.80 mmoles of protons available at pH below 7.5 per gram of composition, when dissolved in 10 ml of water. The compositions herein may comprise a mixture of suitable sources of protons.

The level of protons in a given composition is assessed upon dissolution of the composition in demineralized water.

By a “source of protons” it is meant herein a species with Lewis/Bronsted acid behavior, i.e., a species which in water solution is capable of donating a proton or accepting an electron pair from another species.

By “mmoles of protons available at pH below 7.5 per gram of composition, when dissolved in 10 ml of water” it is meant herein the concentration of protons (in mmoles per gram of composition dissolved in 10 ml of water) available, this means either free protons or protons that may disassociate, at a pH below 7.5, which are capable of being delivered to (alkaline/base) species present in the wash solution and thereby reducing the pH in the wash liquor/solution formed by a conventional laundry detergent, preferably a conventional particulate laundry detergent.

The concentration (in mmoles per gram of composition, when dissolved in 10 ml of water) of available protons in a given composition is equivalent to the amount in mmoles of 1 M Sodium Hydroxide solution (1 mol of NaOH in 1 liter of demin. water) needed to bring the pH of 100 grams of the given composition up to a value of 7.5 and divided by 100.

For example, for 100 grams of a composition consisting of 5 grams citric acid a and 95 grams of sodium sulfate (citric acid has mol. wt. of 192.12 and three acidic protons donated at a pH below 7.5), and dissolved into 1 liter of water, 79 mmoles of 1 M Sodium Hydroxide solution are required to bring the pH up to a value of 7.5. This means that said composition comprise a source of protons donating protons in water at a pH below 7.5 and wherein said source of protons is present at a concentration of 0.79 mmoles of protons available at pH below 7.5 per gram of composition, when dissolved in 10 ml of water.

Moreover, for 100 grams of a composition consisting of 9 grams citric acid and 91 grams of sodium sulfate (citric acid has mol. wt. of 192.12 and three acidic protons donated at a pH below 7.5), and dissolved into 1 liter of water, 140 mmoles of 1 M Sodium Hydroxide solution are required to bring the pH up to a value of 7.5. This means that said composition comprise a source of protons donating protons in water at a pH below 7.5 and wherein said source of protons is present at a concentration of 1.4 mmoles of protons available at pH below 7.5 per gram of composition, when dissolved in 10 ml of water.

Alternatively, for 100 grams of a composition consisting of 5 grams succinic acid and 95 grams of sodium sulfate (succinic acid has mol. wt. of 118.09 and two acidic protons donated at a pH below 7.5), and dissolved into 1 liter of water, 85 mmoles of 1 M Sodium Hydroxide solution are required to bring the pH up to a value of 7.5. This means that said composition comprise a source of protons donating protons in water at a pH below 7.5 and wherein said source of protons is present at a concentration of 0.85 mmoles of protons available at pH below 7.5 per gram of composition, when dissolved in 10 ml of water.

Furthermore, for 100 grams of a composition consisting of 4 grams succinic acid, 4 grams of citric acid and 92 grams of sodium chloride, and dissolved into 1 liter of water, 130 mmoles of 1 M Sodium Hydroxide solution are required to bring the pH up to a value of 7.5. This means that said composition comprise a source of protons donating protons in water at a pH below 7.5 and wherein said source of protons is present at a concentration of 1.30 mmoles of protons available at pH below 7.5 per gram of composition, when dissolved in 10 ml of water.

The source of protons herein preferably is present at a concentration of at least 0.80, preferably at least 0.90, more preferably 1.0, even more preferably 1.1, yet more preferably 1.8, still more preferably 2.0 and most preferably 2.5 mmoles of protons available at pH below 7.5 per gram of composition, when dissolved in 10 ml of water.

In a preferred embodiment herein, the source of protons herein may be present at a concentration of up to 5, preferably up to 4.5, more preferably 4, even more preferably 3.5, yet more preferably 3.0, still more preferably 2.7 mmoles of protons available at pH below 7.5 per gram of composition, when dissolved in 10 ml of water.

Suitable sources of protons herein may be organic or inorganic. Suitable organic sources of protons herein are selected from the group consisting of: succinic acid, malonic acid, citric acid, glutaric acid, adipic acid, pimelic acid, suberic acid, azelaic acid, phtalic acid, isophthalic acid, terephthalic acid, hemimellitic acid, trimellitic acid, trimesic acid, mellophanic acid, prehnitic acid, pyromellitic acid, benzenepentacarboxylic acid, and mellitic acid and mixtures thereof. Suitable inorganic sources of protons herein are selected from the group consisting of: hydrogen-sulfuric acid, and dihydrogen-phosphoric acid, and mixtures thereof. Preferably said source of protons herein is selected from the group consisting of citric acid, succinic acid, malonic acid, glutaric acid, and adipic acid and mixtures thereof. More preferably said source of protons herein is selected from the group consisting of citric acid, succinic acid and malonic acid, and mixtures thereof. Most preferably said source of protons herein is citric acid.

Not suitable as sources of protons herein are for example sodium hydrogen carbonate, ammonium sulfate, mono ethanol-ammonium sulfate, percarboxylic acids (such as imido-type peroxy acids, like PAP), peracetic acid and diperpimelic acid. Indeed, without being limited by theory, the above listed un-suitable sources of protons fail to donate (or at least sufficiently donate) protons at a pH below 7.5.

In a highly preferred embodiment herein, said source of protons does not include the imido-type peroxy acid present in the compositions according to the present invention.

In a preferred embodiment herein, the composition herein comprises citric acid at concentration of at least 0.051 grams per gram of composition (resulting in a concentration of at least 0.80 mmoles of protons available at pH below 7.5 per gram of composition, when dissolved in 10 ml of water), preferably at least 0.083 grams per gram of composition (resulting in a concentration of at least 1.3 mmoles of protons available at pH below 7.5 per gram of composition, when dissolved in 10 ml of water), more preferably at least 0.118 grams per gram of composition (resulting in a concentration of at least 1.84 mmoles of protons available at pH below 7.5 per gram of composition, when dissolved in 10 ml of water), and most preferably at least 0.138 grams per gram of composition (resulting in a concentration of at least 2.2 mmoles of protons available at pH below 7.5 per gram of composition, when dissolved in 10 ml of water).

In another preferred embodiment herein, the composition herein comprises succinic acid at concentration of at least 0.047 grams per gram of composition (resulting in a concentration of at least 0.80 mmoles of protons available at pH below 7.5 per gram of composition, when dissolved in 10 ml of water), preferably at least 0.076 grams per gram of composition (resulting in a concentration of at least 1.3 mmoles of protons available at pH below 7.5 per gram of composition, when dissolved in 10 ml of water), more preferably at least 0.109 grams per gram of composition (resulting in a concentration of at least 1.84 mmoles of protons available at pH below 7.5 per gram of composition, when dissolved in 10 ml of water), and most preferably at least 0.127 grams per gram of composition (resulting in a concentration of at least 2.2 mmoles of protons available at pH below 7.5 per gram of composition, when dissolved in 10 ml of water).

In another preferred embodiment herein, the composition herein comprises malonic acid at concentration of at least 0.0416 grams per gram of composition (resulting in a concentration of at least 0.80 mmoles of protons available at pH below 7.5 per gram of composition, when dissolved in 10 ml of water), preferably at least 0.0675 grams per gram of composition (resulting in a concentration of at least 1.3 mmoles of protons available at pH below 7.5 per gram of composition, when dissolved in 10 ml of water), and more preferably at least 0.096 grams per gram of composition (resulting in a concentration of at least 1.84 mmoles of protons available at pH below 7.5 per gram of composition, when dissolved in 10 ml of water), and most preferably at least 0.112 grams per gram of composition (resulting in a concentration of at least 2.2 mmoles of protons available at pH below 7.5 per gram of composition, when dissolved in 10 ml of water).

In another preferred embodiment herein, the composition herein comprises glutaric acid at concentration of at least 0.0528 grams per gram of composition (resulting in a concentration of at least 0.80 mmoles of protons available at pH below 7.5 per gram of composition when dissolved in 10 ml of water), preferably at least 0.0859 grams per gram of composition (resulting in a concentration of at least 1.3 mmoles of protons available at pH below 7.5 per gram of composition when dissolved in 10 ml of water), and most preferably at least 0.143 grams per gram of composition (resulting in a concentration of at least 2.2 mmoles of protons available at pH below 7.5 per gram of composition when dissolved in 10 ml of water).

In another preferred embodiment herein, the composition herein comprises adipic acid at concentration of at least 0.0585 grams per gram of composition (resulting in a concentration of at least 0.80 mmoles of protons available at pH below 7.5 per gram of composition when dissolved in 10 ml of water), preferably at least 0.0950 grams per gram of composition (resulting in a concentration of at least 1.3 mmoles of protons available at pH below 7.5 per gram of composition when dissolved in 10 ml of water), and more preferably at least 0.158 grams per gram of composition (resulting in a concentration of at least 2.2 mmoles of protons available at pH below 7.5 per gram of composition when dissolved in 10 ml of water).

In yet another preferred embodiment herein, the composition herein comprises sodium hydrogen-sulfuric acid at concentration of at least 0.156 grams per gram of composition (resulting in a concentration of at least 1.84 mmoles of protons available at pH below 7.5 per gram of composition when dissolved in 10 ml of water)

The Applicant has found that by reducing the pH in the wash liquor formed by an conventional laundry detergent, preferably a conventional particulate laundry detergent (including powders, granules, pearls and tablets) and an imido-type peroxy acid-based, preferably PAP-based, bleach additive, the through-the-wash bleaching performance of the bleach additive can be significantly increased. Indeed, it has surprisingly been found that at a pH above 9, the imido-type peroxy acid molecule, preferably the PAP molecule, is irreversibly hydrolyzed to a hydrophilic molecule, which fails to be able to penetrate the hydrophobic fibres of fabrics and therefore also failing to be able to penetrate the bleachable stains present thereon. This leads to a limited bleaching performance on stained fabrics, whilst maintaining a good bleaching performance of the wash liquor, which is an aqueous solution and thus hydrophilic.

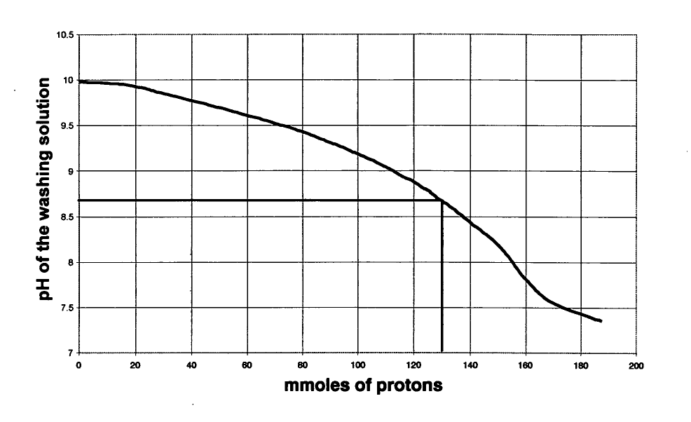

Indeed, the bleaching activity of imido-type peroxy acids is most optimal in a pH range of from 9.0 to 8.0 For example, the PAP bleaching activity is most optimal at a pH of 8.4. However, conventional laundry detergents and in particular conventional granular laundry detergent are heavily buffered compositions providing a wash liquor having a pH in the range of 9.8-10. Indeed, as shown in FIG. 1 herein, a significant buffering can be observed for conventional granular laundry detergents.

As shown in FIG. 1, in order to reduce the pH of the wash liquor/solution formed by conventional particulate laundry detergent to below 9, preferably to below 8.8, high amounts of protons are needed. Indeed, at least 80 mmoles of protons are needed to bring the pH of the wash solution to a pH below 9.5 and 130 mmoles of protons are needed to bring the pH of the wash solution to a pH below 8.8.

The protons have to be added in conjunction with the imido-type peroxy acid-containing particulate laundry bleach additive as described herein. Indeed, the bleach additive herein needs to contain high amounts of free acid (i.e., available protons) also referred to as reserve acidity. Such reserve acidity is provided by the source of protons herein.

For example, at a dosage of 162 grams of particulate bleach additive composition according to the present invention per wash-load 130 mmoles of available protons at pH below 7.5 (162 grams times 0.80 mmoles of protons available at pH below 7.5 per gram of composition) are available to off-set the buffering of the wash solution provided by the particulate laundry detergent.

It has been found that by adding a sufficient amount of reserve acidity into an imido-type peroxy acid-based bleach additive of the present invention, the bleaching performance of the additive in a through-the-wash bleach operation is significantly increased in comparison to bleach additives containing no or too little reserve acidity used in a similar operation.

Optional Ingredients

The compositions herein may further comprise a variety of other optional ingredients such as surfactants, filers, chelating agents, radical scavengers, antioxidants, stabilisers, builders, soil suspending polymer, polymeric soil release agents, dye transfer inhibitor, solvents, suds controlling agents, suds booster, brighteners, perfumes, pigments, dyes and the like.

Fillers

The compositions of the present invention may comprise a filler salt as a highly preferred though option ingredient.

Suitable filler salts herein are selected from the group consisting of sodium sulfate, sodium chloride, sodium tripolyphosphate “STPP” and the like.

Typically, the compositions according to the present invention may comprise from up to 75% by weight of the total composition of a filler salt or a mixture thereof, preferably from 70% to 10% and more preferably from 60% to 30%.

Surfactants

The compositions of the present invention may comprise a surfactant or a mixture thereof including nonionic surfactants, anionic surfactants, cationic surfactants, zwitterionic surfactants and/or amphoteric surfactants.

Typically, the compositions according to the present invention may comprise from 0.01% to 50% by weight of the total composition of a surfactant or a mixture thereof, preferably from 0.1% to 30% and more preferably from 0.2% to 10%.

Chelating Agents

The compositions of the present invention may comprise a chelating agent as an optional ingredient.

Suitable phosphonate chelating agents for use herein may include alkali metal ethane 1-hydroxy diphosphonates (HEDP), alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agents to be used herein are diethylene triamine penta methylene phosphonate (DTPMP) and ethane 1-hydroxy diphosphonate (HEDP). Such phosphonate chelating agents are commercially available from Monsanto under the trade name DEQUEST®.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4,704,233, Nov. 3, 1987, to Hartman and Perkins. Ethylenediamine N,N′-disuccinic acids is, for instance, commercially available under the tradename ssEDDS® from Palmer Research Laboratories.

Suitable amino carboxylates to be used herein include ethylene diamine tetra acetates, diethylene triamine pentaacetates, diethylene triamine pentaacetate (DTPA),N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS® and methyl glycine di-acetic acid (MGDA).

Further carboxylate chelating agents to be used herein include salicylic acid, aspartic acid, glutamic acid, glycine, malonic acid or mixtures thereof.

Another chelating agent for use herein is of the formula: 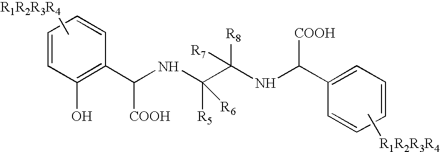
wherein R₁, R₂, R₃, and R₄ are independently selected from the group consisting of —H, alkyl, alkoxy, aryl, aryloxy, —Cl, —Br, —NO₂, —C(O)R′, and —SO₂R″; wherein R′ is selected from the group consisting of —H, —OH, alkyl, alkoxy, aryl, and aryloxy; R″ is selected from the group consisting of alkyl, alkoxy, aryl, and aryloxy; and R₅, R₆, R₇, and R₈ are independently selected from the group consisting of —H and alkyl.

Particularly preferred chelating agents to be used herein are amino aminotri(methylene phosphonic acid), di-ethylene-triamino-pentaacetic acid, diethylene triamine penta methylene phosphonate, 1-hydroxy ethane diphosphonate, ethylenediamine N,N′-disuccinic acid, and mixtures thereof.

Typically, the compositions according to the present invention comprise up to 5% by weight of the total composition of a chelating agent, or mixtures thereof, preferably from 0.01% to 1.5% by weight and more preferably from 0.01% to 0.5%.

Soil Suspending Polymer

The compositions according to the present invention may further comprise a soil suspending polyamine polymer or mixtures thereof, as an optional ingredient. Any soil suspending polyamine polymer known to those skilled in the art may be used herein. Particularly suitable polyamine polymers for use herein are polyalkoxylated polyamines.

Typically, the compositions comprise up to 10% by weight of the total composition of such a soil suspending polyamine polymer or mixtures thereof, preferably from 0.1% to 5% and more preferably from 0.3% to 2%.

The compositions herein may also comprise other polymeric soil release agents known to those skilled in the art. Such polymeric soil release agents are characterised by having both hydrophilic segments, to hydrophilize the surface of hydrophobic fibres, such as polyester and nylon, and hydrophobic segments, to deposit upon hydrophobic fibres and remain adhered thereto through completion of washing and rinsing cycles and, thus, serve as an anchor for the hydrophilic segments. This can enable stains occurring subsequent to treatment with the soil release agent to be more easily cleaned in later washing procedures.

If utilized, soil release agents will generally comprise from 0.01% to 10.0%, by weight, of the detergent compositions herein, typically from 0.1% to 5%, preferably from 0.2% to 3.0%.

Dye Transfer Inhibitor

The compositions of the present invention may also include one or more materials effective for inhibiting the transfer of dyes from one dyed surface to another during the cleaning process. Generally, such dye transfer inhibiting agents include polyvinyl pyrrolidone polymers, polyamine N-oxide polymers, co-polymers of N-vinylpyrrolidone and N-vinylimidazole, manganese phthalocyanine, peroxidases, and mixtures thereof. If used, these agents typically comprise from 0.01% to 10% by weight of the composition, preferably from 0.01% to 5%, and more preferably from 0.05% to 2%.

Brightener

Any optical brighteners, fluorescent whitening agents or other brightening or whitening agents known in the art can be incorporated in the instant compositions when they are designed for fabric treatment or laundering, at levels typically from about 0.05% to about 1.2%, by weight, of the detergent compositions herein.

Minor Ingredients

The composition described herein may also comprise minor ingredients such as pigment or dyes and perfumes.

Processes of Treating Fabrics

The present invention encompasses a process of treating fabrics which comprises the steps of forming an aqueous bath comprising water, a conventional laundry detergent, preferably a granular laundry detergent, and a particulate bleach additive composition according to the present invention, and subsequently contacting said fabrics with said aqueous bath.

In a highly preferred embodiment herein, the particulate bleach additive compositions according to the present invention are dosed herein to provide at least 80 mmoles, preferably 100 mmoles, more preferably 130 mmoles, still more preferably 180 mmoles, most preferably 210 mmoles of protons available at pH below 7.5 per wash-load. Indeed, sufficient amount of said particulate bleach additive composition is added to provide the above amounts of protons available at pH below 7.5.

Typically, the particulate bleach additive compositions according to the present invention are dosed at minimum 15 grams per wash-load, preferably of from 20 grams to 170 grams, more preferably 30 grams to 110 grams. The dosage of the particulate bleach additive composition herein depends on the level of protons available at a pH below 7.5 per gram of composition. Indeed, compositions having levels of protons available at a pH below 7.5 per gram of composition at the minimum required level herein (0.8 mmoles per gram of composition) require a higher dosage (162.5 grams to, e.g., donate 130 mmoles of protons available at pH below 7.5 per wash-load). Compositions having levels of protons available at a pH below 7.5 per gram of composition above the minimum required level herein (e.g., 1.3 mmoles per gram of composition) require a lower dosage (100 grams to, e.g., donate 130 mmoles of protons available at pH below 7.5 per wash-load).

The processes of treating, preferably bleaching, fabrics according to the present invention delivers effective whiteness performance as well as effective stain removal performance.

The process of treating fabrics herein comprises the steps of forming an aqueous bath comprising water, a conventional laundry detergent and a particulate bleach additive composition, as described herein, subsequently contacting said fabrics with said aqueous bath.

By “conventional laundry detergent” it is meant herein, a laundry detergent composition currently available on the market. Preferably, said conventional laundry detergent comprises at least one surfactant. Said laundry detergent compositions may be formulated as particulates (including powders, pearls, granules, tablets and the like), liquids (liquids, gels, and the like) as well as detergent forms based on water-soluble or water-permeable pouches comprising liquids and/or particulates (such as liquid-tabs). Suitable particulate laundry detergent compositions are for example DASH powder®, ARIEL tablets®, ARIEL powder® and other products sold under the trade names ARIEL® or TIDE®.

In a preferred embodiment herein, the conventional laundry detergent is a conventional particulate laundry detergent more preferably a conventional powder, pearl, granule or tablet laundry detergent.

In a preferred embodiment according to the present invention, the conventional laundry detergent as described herein and, the particulate bleach additive composition herein are dissolved or dispersed, preferably substantially dissolved or dispersed, in the aqueous bath formed in the process according to the present invention. By “substantially dissolved or dispersed” it is meant herein, that at least 50%, preferably at least 80%, more preferably at least 90%, even more preferably at least 95%, still more preferably at least 98%, and most preferably at least 99%, of said conventional laundry detergent and/or said particulate bleach additive composition are dissolved or dispersed in the aqueous bath formed in the process according to the present invention.

The particulate bleach additive composition and the conventional detergent composition may be delivered into the washing machine either by charging the dispenser drawer of the washing machine with one or both of the detergents or by directly charging the drum of the washing machine with one or both of the detergents. More preferably the particulate bleach additive composition is directly placed into the drum of the washing machine, preferably using a dosing device, such as a dosing ball (such as the Vizirette®). Even more preferably the particulate bleach additive composition and the conventional detergent composition are both placed into the drum of the washing machine, preferably using suitable dosing devices such as dosing balls, dosing nets etc. The particulate bleach additive composition is preferably delivered to the main wash cycle of the washing machine before, but more preferably at the same time as the conventional detergent composition.

During the processes according to the present invention the particulate bleach additive compositions herein is typically used in dissolved form. By “in dissolved form”, it is meant herein that the particulate bleach additive compositions according to the present invention may be dissolved by the user, preferably in water. The dissolution occurs in a washing machine. Said compositions can be dissolved up to 500 times its own weight, preferably from 5 to 350 times and more preferably from 10 to 200 times.

Packaging Form of the Particulate Compositions:

Depending on the end-use envisioned, the compositions herein can be packaged in a variety of containers including conventional boxes, tubs etc.

The invention is further illustrated by the following examples.

### EXAMPLES

The following examples will further illustrate the present invention. The compositions are made by combining the listed ingredients in the listed proportions (weight % unless otherwise specified). The following Examples are meant to exemplify compositions according to the present invention but are not necessarily used to limit or otherwise define the scope of the present invention.

Compositions
(% weight)

| | I | II | III | IV | V |
|---|---|---|---|---|---|
| PAP | 4.0 | 4.0 | 4.0 | 4.0 | 5.0 |
| Succinic acid | 10.0 | 17.1 | 7.1 | 5.0 | 0.0 |
| Citric acid | 0.0 | 0.0 | 0.0 | 0.0 | 15.0 |
| malonic acid | 0.0 | 0.0 | 0.0 | 0.0 | 0.0 |
| Na hydrogen- | 0.0 | 0.0 | 0.0 | 15.0 | 0.0 |
| sulfate | | | | | |
| Sodium sulfate | balance | balance | balance | balance | balance |
| mmoles of | 1.7 | 2.9 | 1.2 | 2.1 | 2.3 |
| protons per | | | | | |
| grams of | | | | | |
| composition | | | | | |
| | VI | VII | VIII | IX | X |
| PAP | 5.0 | 5.0 | 6.0 | 7.8 | 7.8 |
| Succinic acid | 0.0 | 0.0 | 0.0 | 0.0 | 22.2 |
| Citric acid | 20.0 | 25.0 | 18.0 | 25.0 | 0.0 |
| malonic acid | 0.0 | 0.0 | 0.0 | 0.0 | 0.0 |
| Na hydrogen- | 0.0 | 0.0 | 7.0 | 0.0 | 0.0 |
| sulfate | | | | | |
| Sodium sulfate | balance | balance | balance | balance | balance |
| mmoles of | 3.1 | 3.9 | 3.4 | 3.9 | 3.8 |
| protons per | | | | | |
| grams of | | | | | |
| composition | | | | | |
| | XI | XII | XIII | XIV | XV |
| PAP | 7.0 | 7.0 | 8.0 | 8.0 | 9.3 |
| Succinic acid | 17.5 | 0.0 | 0.0 | 0.0 | 0.0 |
| Citric acid | 0.0 | 22.5 | 25.7 | 0.0 | 30.0 |
| malonic acid | 0.0 | 0.0 | 0.0 | 0.0 | 0.0 |
| Na hydrogen- | 0.0 | 0.0 | 0.0 | 37.1 | 0.0 |
| sulfate | | | | | |
| Sodium sulfate | balance | balance | balance | balance | balance |
| mmoles of | 3.0 | 3.5 | 4.0 | 3.1 | 4.7 |
| protons per | | | | | |
| grams of | | | | | |
| composition | | | | | |
| | XVI | XVII | XVIII | XIX | XX |
| PAP | 9.3 | 6.7 | 8.0 | 9.0 | 9.0 |
| Succinic acid | 0.0 | 0.0 | 17.1 | 30.0 | 0.0 |
| Citric acid | 30.0 | 30.0 | 0.0 | 0.0 | 0.0 |
| Malonic acid | 0.0 | 0.0 | 0.0 | 0.0 | 20.0 |
| Na hydrogen- | 0.0 | 0.0 | 0.0 | 0.0 | 0.0 |
| sulfate | | | | | |
| Sodium sulfate | balance | balance | balance | balance | balance |
| mmoles of | 4.7 | 4.7 | 2.9 | 5.1 | 3.8 |
| protons per | | | | | |
| grams of | | | | | |
| composition | | | | | |
| | XXI | XXII | XXIII | XXIV | XXV |
| PAP | 9.0 | 9.0 | 10.0 | 15 | 20 |
| Succinic acid | 0.0 | 0.0 | 0.0 | 0.0 | 0.0 |
| Citric acid | 0.0 | 0.0 | 33.3 | 25 | 25 |
| Malonic acid | 10.0 | 7.0 | 0.0 | 0.0 | 0.0 |
| Na hydrogen- | 0.0 | 0.0 | 0.0 | 0.0 | 0.0 |
| sulfate | | | | | |
| Sodium sulfate | balance | balance | balance | balance | balance |
| mmoles of | 1.9 | 1.3 | 5.2 | 3.9 | 3.9 |
| protons per | | | | | |
| grams of | | | | | |
| composition | | | | | |
| | XXVI | XXVII | XXVIII | XXIX | XXX |
| PAP | 7.8 | 5.6 | 4.0 | 3.3 | 2.5 |
| Succinic acid | 0.0 | 0.0 | 0.0 | 0.0 | 0.0 |
| Citric acid | 25.0 | 18.0 | 18.0 | 33.3 | 25.0 |
| Malonic acid | 0.0 | 0.0 | 0.0 | 0.0 | 0.0 |
| Na hydrogen- | 0.0 | 0.0 | 0.0 | 0.0 | 0.0 |
| sulfate | | | | | |
| Sodium sulfate | balance | balance | balance | balance | balance |
| mmoles of | 3.9 | 2.8 | 2.8 | 5.2 | 3.9 |
| protons per | | | | | |
| grams of | | | | | |
| composition | | | | | |

The mmoles of protons per grams of composition as quoted above are observed upon dissolution of the compositions in 10 ml of demineralized water.

PAP is phthalimido peroxy hexanoic acid available from Ausimont under the tradename Eureco®.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A particulate bleach additive composition comprising an imido-type peroxy acid and a source of protons having at least one acidic moiety donating protons in water at a pH below about 7.5, wherein said composition comprises at least about 0.80 mmoles of protons available at pH below about 7.5 per gram of composition, when dissolved in 10 ml of water.

2. A particulate bleach additive composition according to claim 1, wherein said imido-type peroxy acid is a solid, substantially water insoluble pre-formed imido-type peroxy acid.

3. A particulate bleach additive composition according to claim 1, wherein said imido-type peroxy acid has the general formula: 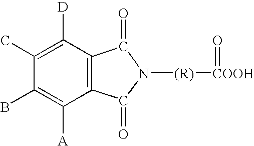
wherein R is about C1-20 alkyl group and where A, B, C and D are independently either hydrogen or substituent groups individually selected from the group consisting of alkyl, hydroxyl, nitro, halogen, amine, ammonium, cyanide, carboxylic, sulphate, sulphonate, aldehydes or mixtures thereof.

4. A particulate bleach additive composition according to claim 1, wherein said imido-type peroxy acid has general formula: 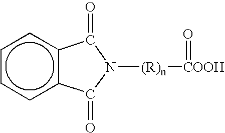
wherein R is about C₁₋₄ alkyl and n is an integer of from about 1 to about 5.

5. A particulate bleach additive composition according to claim 1, wherein said imido-type peroxy acid is an imido-type peroxy alkanoic acid,

6. A particulate bleach additive composition according to claim 1, wherein said imido-type peroxy acid is selected from the group consisting of: ε-phthalimido peroxy hexanoic acid; phthalimido peroxy heptanoic acid; phthalimido peroxy octanoic acid; phthalimido peroxy nonanoic acid; and Phthalimido peroxy decanoic acid; and mixtures thereof.

7. A particulate bleach additive composition comprising ε-phthalimido peroxy hexanoic acid and a source of protons having at least one acidic moiety donating protons in water at a pH below about 7.5, wherein said composition comprises at least about 0.80 mmoles of protons available at pH below about 7.5 per gram of composition, when dissolved in 10 ml of water.

8. A particulate bleach additive composition according to claim 1, wherein said composition comprises of from about 0.1% to about 30% by weight of the total composition of said imido-type peroxy acid.

9. A particulate bleach additive composition according to claim 1, wherein said composition comprises of from about 3% to about 40%, by weight of the total composition of said imido-type peroxy acid.

10. A particulate bleach additive composition according to claim 1, wherein said source of protons is present at a concentration of at least about 0.90 mmoles of protons available at pH below about 7.5 per gram of composition, when dissolved in 10 ml of water.

11. A particulate bleach additive composition according to claim 1, wherein said source of protons is present at a concentration of up to about 5 mmoles of protons available at pH below about 7.5 per gram of composition when dissolved in 10 ml of water.

12. A particulate bleach additive composition according to claim 1, wherein said source of protons is an organic source of protons selected from the group consisting of: succinic acid, malonic acid, citric acid, glutaric acid, adipic acid, pimelic acid, suberic acid, azelaic acid, phtalic acid, isophthalic acid, terephthalic acid, hemimellitic acid, trimellitic acid, trimesic acid, mellophanic acid, prehnitic acid, pyromellitic acid, benzenepentacarboxylic acid, and mellitic acid and mixtures thereof.

13. A particulate bleach additive composition according to claim 1, wherein said source of protons is an inorganic source of protons selected from the group consisting of: hydrogen-sulfuric acid, and dihydrogen-phosphoric acid, and mixtures thereof.

14. A particulate bleach additive composition according to claim 1, wherein said source of protons is selected from the group consisting of citric acid, succinic acid, malonic acid, glutaric acid, and adipic acid and mixtures thereof.

15. A particulate bleach additive composition comprising ε-phthalimido peroxy hexanoic acid and a source of protons having at least one acidic moiety donating protons in water at a pH below about 7.5, wherein said composition comprises at least about 0.80 mmoles of protons available at pH below about 7.5 per gram of composition, when dissolved in 10 ml of water, and wherein said source of protons is selected from the group consisting of citric acid, succinic acid, malonic acid, glutaric acid, and adipic acid and mixtures thereof.

16. A process of treating fabrics which comprises the steps of forming an aqueous bath comprising water, a conventional laundry detergent, preferably a granular laundry detergent, and a particulate bleach additive composition and subsequently contacting said fabrics with said aqueous bath, wherein said particulate bleach additive composition comprises an imido-type peroxy acid and a source of protons having at least one acidic moiety donating protons in water at a pH below about 7.5, and wherein said composition comprises at least about 0.80 mmoles of protons available at pH below about 7.5 per gram of composition, when dissolved in 10 ml of water

17. A process of treating fabrics according to claim 16, wherein sufficient amount of said particulate bleach additive composition is added to provide at least about 80 mmoles, preferably about 100 mmoles, more preferably about 130 mmoles, still more preferably about 180 mmoles, most preferably about 210 mmoles of protons available at pH below about 7.5.

18. A method of providing effective bleaching performance on stained fabrics to a particulate bleach additive composition comprising an imido-type peroxy acid when used in conjunction with a conventional particulate laundry detergent by adding to said composition a source of protons having at least one acidic moiety donating protons in water at a pH below about 7.5, in an amount so that said composition comprises at least about 0.80 mmoles of protons available at pH below about 7.5 per gram of composition when dissolved in 10 ml of water.
